(19) United States
(12) Patent Application Publication
(10) Pub. No.: US 2011/0145837 A1
(43) Pub. Date: Jun. 16, 2011

(54) Filtering Broadcast Recipients In A Multiprocessing Environment

(76) Inventor: Kenneth S. Bower, Fort Collins, CO (US)

(21) Appl. No.: 12/637,689

(22) Filed: Dec. 14, 2009

(51) Int. Cl. G06F 9/46

(52) U.S. Cl. 719/317

(57) ABSTRACT

Systems and methods of filtering broadcast recipients in a multiprocessing environment are disclosed. An exemplary method may include receiving a message generated in the multiprocessing environment at a management agent. The method may also include determining which components in the multiprocessing environment already received the message. The method may also include forwarding the message to only those components in the multiprocessing environment which did not already receive the message.

### BACKGROUND

Multiprocessing systems which provide enhanced processing capacity are becoming increasingly commonplace. Exemplary multiprocessing systems may have multiple processing resources, including multiple processing units on each computing chip. Multiple computing chips may also be linked to one another. Commonly, a bus (e.g., a front side bus) is implemented to link the processing resources to one another, in addition to linking to other shared resources (e.g., memory, I/O, and networking).

More recently, the Quick Path Interconnect (QPI) was introduced as an alternative to the front side bus. QPI is a point-to-point processor interconnect. QPI links may be used to connect one or more of the processing units and/or I/O chips (e.g., an I/O controller or bridge to a PCIe device). The processing units and/or I/O chips may also be referred to as QPI agents.

During operation, any of the QPI agents may generate a request to broadcast a message to other QPI agents. A management agent on the computing chip ensures that the message is broadcast to each QPI agent. However, local QPI agents may receive duplicates of the message. For example, a QPI agent may receive the message via a direct connection with the QPI requesting the broadcast, and that same QPI agent may receive the same message again when the message is broadcast by the management agent. This is particularly inefficient in larger, more complex systems with multiple QPI agents, and even more so with multiple interconnected computing chips.

### BRIEF DESCRIPTION OF THE DRAWINGS

FIG. 1 is a high level schematic diagram of an exemplary multiprocessing environment.

FIGS. 2a and 2b are high level schematic diagrams illustrating filtering broadcast recipients in a multiprocessing environment.

FIG. 3 is an illustration of using a broadcast list and programming bits which may be implemented by a management agent in a multiprocessing environment to filter broadcast recipients

FIG. 4 is a flowchart illustrating exemplary operations which may be implemented to filter broadcast recipients in a multiprocessing environment.

### DETAILED DESCRIPTION

Briefly, systems and methods described herein may be implemented to filter broadcast recipients in a multiprocessing environment. Although not intended to be limiting, the multiprocessing environment may be implemented according to the QPI specification. The QPI specification currently defines up to five layers, including: a physical layer, link layer, routing layer, transport layer, and protocol layer. The physical layer includes the wiring, transmitters, and receivers, along with the associated logic for transmitting and receiving. The link layer sends and receives data to the physical layer. The routing layer implements routing tables to route messages (e.g., a 72-bit unit including an 8-bit header and 64 bit payload) in the fabric. The transport layer sends and receives data across the QPI network where the devices are not directly connected. The protocol layer sends and receives packets on behalf of the device.

In exemplary embodiments, the requesting QPI agent issues a request to broadcast a message to at least one other QPI agent, and to a management agent. The management agent maintains a broadcast list of all QPI agents in the multiprocessing environment. The management agent determines which QPI agents have already received the message (e.g., from the issuing QPI agent) and the management agent only broadcasts the message to other QPI agents that have not already received the message.

In exemplary embodiments, the determination by the management agent is programmable, providing flexibility in the type and number of topologies that can be supported. In other words, the program code may be changed for various types and numbers of QPI islands and/or chip interconnections which might be implemented.

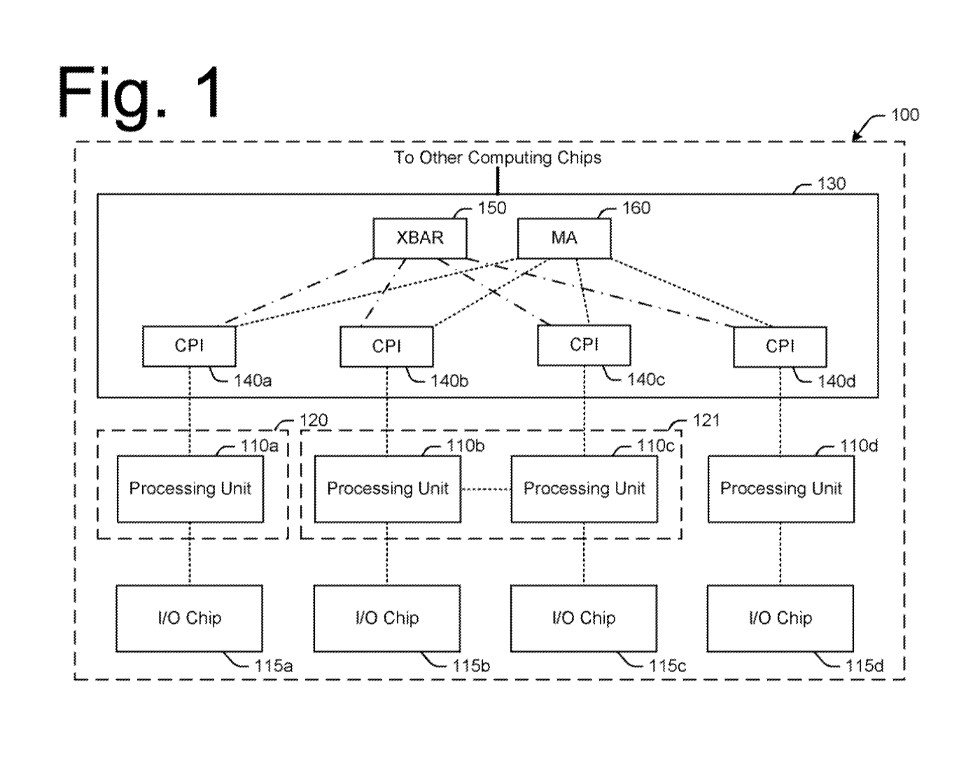

FIG. 1 is a high level schematic diagram of an exemplary multiprocessing environment 100 (e.g., as it may be implemented in an enterprise server). In an exemplary embodiment, multiprocessing environment 100 may include any number of QPI agents. QPI agents include processors or processing units 110a-d (also collectively referred to simply as processing units 110 when not calling out a specific processing unit or units). QPI agents also include I/O chips 115a-d (collectively referred to simply as processing units 115 when not calling out a specific I/O chip or chips).

It is noted that the CPI may also be considered a QPI agent, although the CPI is not a recipient of broadcast messages. The processing units 110 and I/O chps 115 are also referred to as “home” agents because these components originate coherent requests, and are recipients of broadcast requests.

One or more processing unit 110 may be grouped as one or more logical groupings, or “QPI islands” (also referred to simply as “islands”). In FIG. 1, two separate islands are shown: island 120 including processing unit 110a, and island 121 including processing units 110b and 110c. Processing unit 110d is not included in any QPI island.

The multiprocessing environment 100 may also include one or more computing chip 130. Although only one computing chip is shown in FIG. 1, multiple chips may be linked together using a suitable fabric. Each computing chip 130 may include a coherent processor interface (CPI) for each processing unit. In FIG. 1, chip 130 includes CPIs 140a-d (collectively referred to simply as CPIs 140 when not calling out a specific CPI) for each of the processing units 110a-d, respectively. The CPIs 140 may be interconnected using a suitable switch or crossbar 150.

The CPIs 140 are connected to a management agent (MA) 160. Briefly, the MA 160 includes a broadcast engine. During operation, the MA 160 receives requests to broadcast messages, and the MA 160 broadcasts the messages in the multiprocessing environment 100. The MA 160 may execute program code (e.g., firmware) to determine which recipients in the multiprocessing environment 100 to broadcast the message, as will be described in more detail below.

QPI links (illustrated by the dotted lines in FIG. 1) may interconnect the various components in the multiprocessing environment 100. In an exemplary embodiment, the QPI links may be implemented between a processing unit and an I/O chip. For example, a QPI link is shown between processing unit 110a and I/O chip 115a; and another QPI link is shown between processing unit 110b and I/O chip 115b. QPI links may also be implemented between processing units. For example, a QPI link is shown between processing units 110b and 110c in QPI island 121. QPI links may also be provided between the processing units 110 and the CPIs 140. For example, QPI links are shown between each of the processing units 110a-d and each of the CPIs 140a-d, respectively.

Before continuing, it is noted that the arrangement shown in FIG. 1 is only for purposes of illustration, and not intended to be limiting. Any suitable topology including any number of QPI agents and computing chips may be implemented. It is also noted that exemplary embodiments described herein are not limited to being implemented in server computers. Multiprocessing environments may be implemented in other computing devices, including but not limited to laptop or personal computers (PCs), workstations, appliances, etc.

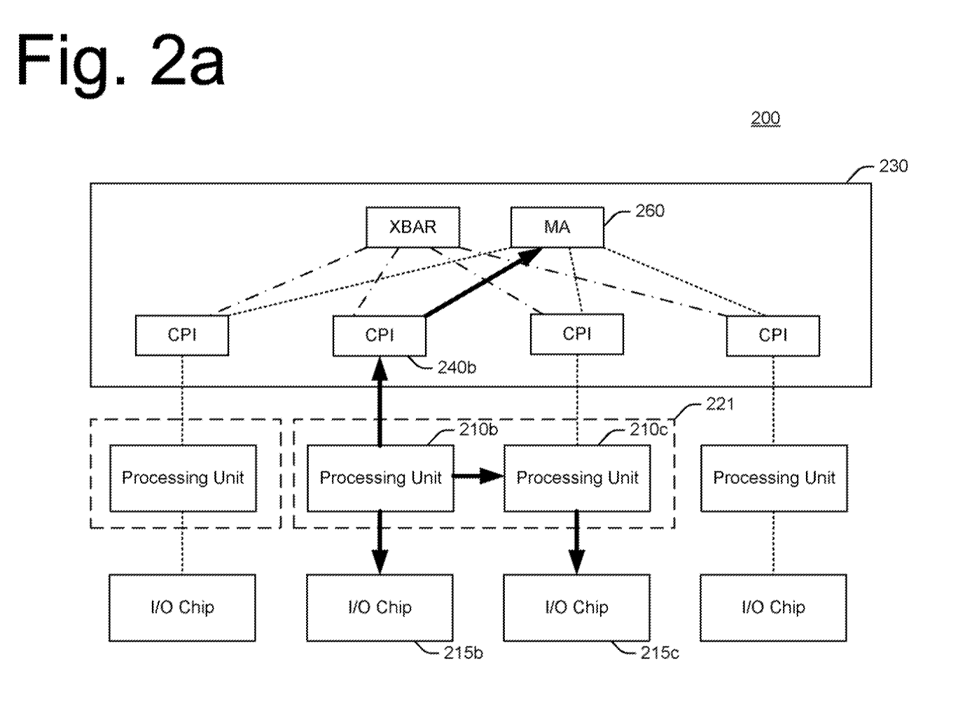

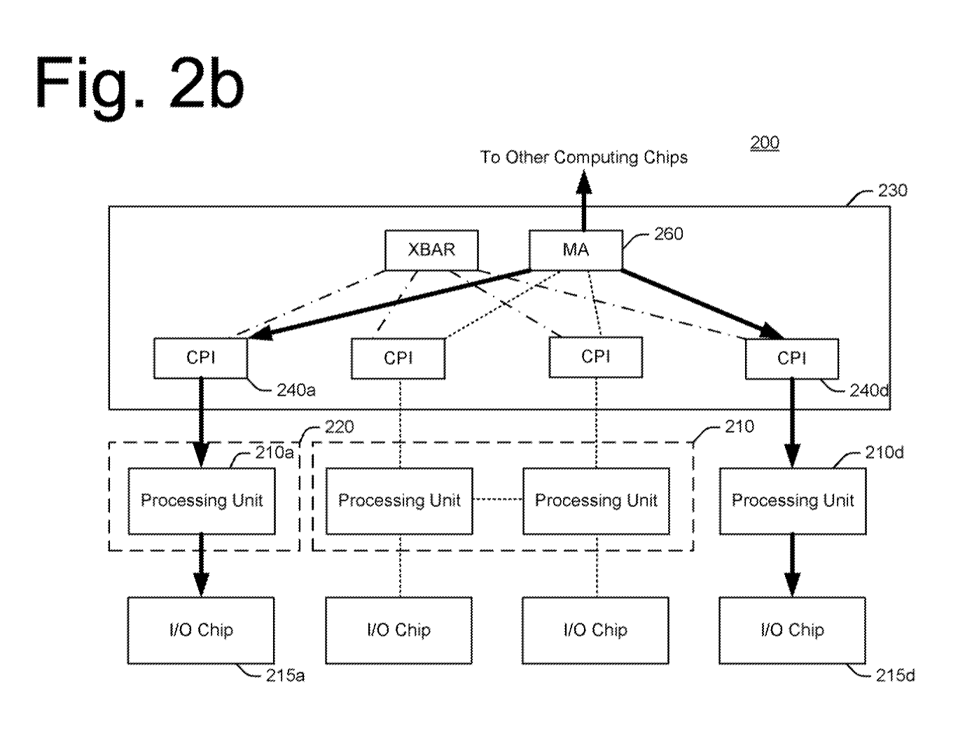

FIGS. 2a and 2b are high level schematic diagrams illustrating filtering broadcast recipients in a multiprocessing environment 200. For purposes of this illustration, the multiprocessing environment 200 has a similar topology as that already described above with reference to the multiprocessing environment 100 described above for FIG. 1. Therefore, the individual components and topology are not described again.

Also, for purposes of simplification, each component in FIG. 2 is not referenced. As discussed above, however, multiprocessing environments are not limited to any particular configuration.

In this example, processing unit 210b generates a message and issues that message directly to processing unit 210c on the same QPI island 121 and I/O chips 215b, and via processing unit 210c, to I/O chip 215c, as illustrated by the darkened arrows in FIG. 2a. In addition, processing unit 210b also issues a request to broadcast the message to the MA 260 via CPI 240b, as illustrated by the darkened arrows in FIG. 2a.

The MA 260 receives the request to broadcast the message from processing unit 210b and determines which of the QPI agents have already received the message. As just described in this example, processing unit 210c on QPI island 121, and I/O chips 215b and 215c have already received the message. Therefore, the MA 260 determines that the message should not be re-issued to processing unit 210c on QPI island 121, and I/O chips 215b and 215c.

Instead, as shown in FIG. 2b, the MA 260 only broadcasts the message to those QPI agents which have not already received the message. In this example, MA 260 broadcasts the message to CPI 240a and 240d, processing unit 210a in QPI island 120, and I/O chips 215a and 215d, as illustrated by the darkened arrows in FIG. 2b. Also in this example, MA 260 broadcasts the message to other computing chips in the multiprocessing environment 200, as illustrated by the darkened arrow at the top of the page.

More specifically, the MA 160 contains a broadcast engine that implements a broadcast list to determine which QPI agents should receive the message. The broadcast list may include all possible recipients from a single broadcast engine. In order to maintain topology flexibility and to allow for the case where the original broadcast requester may or may not send the transaction to other recipients in some subset of the overall topology and thus necessitate that the broadcast engine not duplicate those requests, a method of programmatically filtering the recipients from the broadcast list which may have already received the transaction from the original requester is implemented.

The broadcast list may be implemented, e.g., as a data structure including a number of fields. The broadcast list is used to generate recipient destination module IDs. The destination module ID number may be a 12 bit number, where bits 11 and 10 denote the type of recipient. Bit 9 is known as the QPI island number. Bit 6 is known as the processor number. Bits 7:4 are legacy bits which are unused and set to zero. Bits 3:0 denote the chip ID.

In an exemplary embodiment, three filter bits may be implemented: response_filter_sender, response_filter_ci, response_filter_pi. These bits are used to determine whether to filter the original sender, agents with an ID with the opposite ci number, and agents with the opposite pi number, respectively out of the broadcast list. It further filters QPI agents with the opposite ci and pi number if both of those bits are set. One example where this may be implemented is where a local QPI island has been defined to be two processors (e.g., a Nehalem) and a single I/O chip (e.g., a Boxboro). Since all broadcast transactions are non-coherent messages, the possible recipients in the broadcast list are all assigned destination module IDs such as the following:

Processors: {2′01, ci, pi, 4′b0, chip_id[3:0]}

Boxboro: {2′b00, ci, 1′b1, 4′b0, chip_id[3:0]}

In this example, the chip_id is set to zero. The local island then includes two processors with opposite pi numbers and a ci number of 0 (module IDs of 12′h400 and 12′h500). The boxboro similarly has a ci number of 0 (module ID of 12′h100). The processors and the boxboro are programmed such that when they generate a request to broadcast a message, the request is sent to the computing chip to which the processors and the boxboro are attached and to the other two QPI agents in the QPI island. The computing chip then broadcasts the message to all of the other processors and boxboros in the system, excluding the two processors and the boxboro in the same local island of the original requester (e.g., as described above with reference to FIGS. 2a and 2b).

In an exemplary embodiment, the computing chip is programmed with the bits response_filter_sender, and response_filter_pi set. The response_filter_sender bit forces the original requester. This bit also forces the processor with the same ci and pi bits to be excluded if the requester is a boxboro, and the boxboro with the same ci bit as the original requester in the case the requester is a processor. The response_filter_pi bit causes the other processor to be excluded when the original requester is a processor.

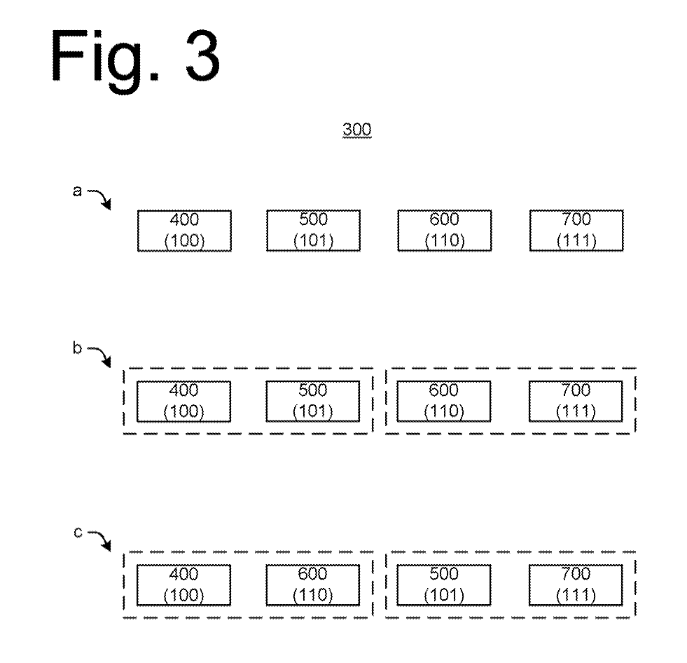

FIG. 3 is an illustration of using a broadcast list and programming bits which may be implemented by a management agent in a multiprocessing environment to filter broadcast recipients. Three examples 300 are shown in FIG. 3. In each of the examples, four processors having IDs 400, 500, 600, and 700 are shown. The binary equivalent for each processor is shown in parenthesis. The second bit in the binary equivalent corresponds to the ci bit, and the third bit in the binary equivalent corresponds to the pi bit. For example, processor 400 has a binary equivalent of 1-0-0. The first 0 is the ci bit and the second 0 is the pi bit. Processor 500 has a binary equivalent of 1-0-1 and so the first 0 is the ci bit and the second 1 is the pi bit. And so forth.

In example (a), each processor comprises its own QPI island. Accordingly, the broadcast list may be generated by only broadcasting the message to those processors having a different ci bit or different pi bit from the issuing processor. That is, if processor 400 issues a request to broadcast a message, the processor 400 has a ci bit of 0 and a pi bit of 0. Therefore, the broadcast list may include any processor with a ci bit of 1 or a pi bit of 1. In this example (a), the broadcast list therefore includes each of the other processors 500, 600 and 700 because at least one of the ci or pi bit are different for each of these processors.

In example (b), processors 400 and 500 comprise a QPI island (illustrated by the dashed box around these two processors) and processors 600 and 700 comprise another QPI island. Accordingly, the broadcast list may be generated by only broadcasting the message to those processors having a different ci bit from the issuing processor. That is, if processor 400 issues a request to broadcast a message, the processor 400 has a ci bit of 0. Therefore, the broadcast list may include any processor with a ci bit of 1. In this example (b), the broadcast list therefore includes the other processors 600 and 700 because the ci bit for each of these processors is 1. However, the broadcast list does not include processor 500, because the ci bit for this processor is also 0. In this example, processor 500 received the message directly from processor 400 and by not including processor 500 in the broadcast list, the processor 500 does not receive the message again from the MA.

In example (c), processors 400 and 600 comprise a QPI island (illustrated by the dashed box around these two processors) and processors 500 and 700 comprise another QPI island. Accordingly, the broadcast list may be generated by only broadcasting the message to those processors having a different pi bit from the issuing processor. That is, if processor 400 issues a request to broadcast a message, the processor 400 has a pi bit of 0. Therefore, the broadcast list may include any processor with a pi bit of 1. In this example (c), the broadcast list therefore includes the other processors 500 and 700 because the pi bit for each of these processors is 1. However, the broadcast list does not include processor 600, because the pi bit for this processor is also 0. In this example, processor 600 received the message directly from processor 400 and by not including processor 600 in the broadcast list, the processor 600 does not receive the message again from the MA.

From these examples, it can be appreciated that the broadcast list may be generated to support multiple topology types based on the programming of the filter bits (e.g., the ci and pi bits). The examples include a local QPI island containing only the requester; and a QPI island containing the requester and one other QPI agent which has a destination module ID differing from the requester by a single bit (either pi or ci). These examples may be extended to other topologies, such as but not limited to a QPI island with 3 other QPI agents with destination module IDS differing by a single pi, a single ci, and both the ci and pi bits, and so forth.

It should be understood that the examples discussed above are provided for purposes of illustration and are not intended to be limiting. Other embodiments will also be readily apparent to those having ordinary skill in the art after becoming familiar with the teachings herein. For example, other embodiments may not include each of the fields described above, and/or may include additional data fields. In other examples, the fields do not need to be maintained in any particular format. Still other embodiments are also contemplated.

Before continuing, it is noted that the exemplary systems discussed above are provided for purposes of illustration. Still other implementations are also contemplated. It is also noted that the exemplary program code described herein is illustrative of suitable program code which may be implemented for filtering broadcast recipients in a multiprocessing environment, and it is not intended to be limiting.

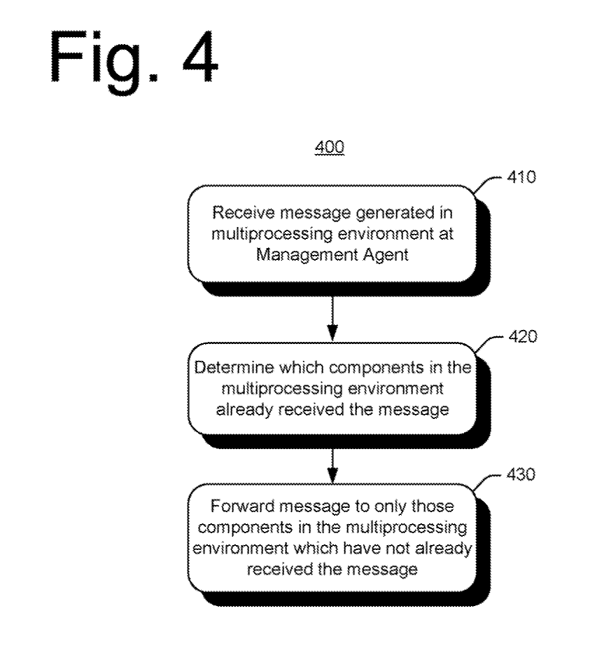

FIG. 4 is a flowchart illustrating exemplary operations which may be implemented to filter broadcast recipients in a multiprocessing environment. Operations 400 may be embodied as logic instructions executable by a processor to implement the described operations. In an exemplary embodiment, the components and connections depicted in the figures may be used to implement the operations.

In operation 410, the method includes receiving a message generated in the multiprocessing environment at a management agent. The message may be received at the management agent from a processing unit, or the message may be received from an I/O chip. In either case, the message may be received at the management agent via one or more QPI link and a CPI.

In operation 420, the method includes determining which components in the multiprocessing environment already received the message. In an exemplary embodiment, the management agent may maintain a list of all components in the multiprocessing environment. The list may identify which components in the multiprocessing environment are directly connected to one another and therefore already received the message. In another exemplary embodiment, the management agent may identify QPI islands in the multiprocessing environment, wherein it is known that all components in each QPI island receive the message from directly from a component in that QPI island generating the message.

In operation 430, the method includes forwarding the message to only those components in the multiprocessing environment which did not already receive the message.

The operations shown and described herein are provided to illustrate exemplary embodiments of filtering broadcast recipients in a multiprocessing environment. It is noted that the operations are not limited to the ordering shown. For example, operations may be reversed or executed simultaneously. Still other operations may also be implemented.

In addition to the specific embodiments explicitly set forth herein, other aspects and implementations will be apparent to those skilled in the art from consideration of the specification disclosed herein. It is intended that the specification and illustrated implementations be considered as examples only, with a true scope and spirit of the following claims.

1. A method of filtering broadcast recipients in a multiprocessing environment, comprising:
receiving at a management agent a message generated in the multiprocessing environment;
determining which components in the multiprocessing environment already received the message; and
forwarding the message to only those components in the multiprocessing environment which did not already receive the message.

2. The method of claim 1 further comprising maintaining a broadcast list of all components in the multiprocessing environment, the broadcast list identifying which components in the multiprocessing environment already received the message based on topology.

3. The method of claim 1 further comprising identifying QPI islands in the multiprocessing environment.

4. The method of claim 3 wherein all QPI agents connected to a QPI island receive the message from directly from a QPI agent in the same QPI island generating the message.

5. The method of claim 1 wherein receiving the message at the management agent is via a coherent processing interface (CPI).

6. The method of claim I wherein receiving the message at the management agent is from a processing unit.

7. The method of claim 1 wherein receiving the message at the management agent is from an I/O chip.

8. The method of claim I wherein receiving the message at the management agent is via at least one QPI link.

9. A system of filtering broadcast recipients in a multiprocessing environment, comprising:
a plurality of multiprocessing units;
a plurality of coherent processing interfaces (CPI), each CPI connected to each of the plurality of multiprocessing units via a QPI link;
a management agent associated with each CPI, the management agent configured to receive a message from one of the plurality of CPIs and determine which components in the multiprocessing environment already received the message, the management agent further configured to forward the message to only those components in the multiprocessing environment which did not already receive the message.

10. The system of claim 9 further comprising at least one I/O chip connected to at least one of the processing units via a QPI link, wherein the I/O chip is configured to generate and receive the message.

11. The system of claim 9 wherein the management agent is connected to another computing chip in the multiprocessing environment via a communications fabric.

12. The system of claim 9 wherein the management agent maintains a broadcast list of all components in the multiprocessing environment, the broadcast list identifying which components in the multiprocessing environment already received the message based on topology.

13. The system of claim 9 further comprising at least one QPI island in the multiprocessing environment.

14. The system of claim 9 wherein all components in a QPI island receive the message directly from a component in the QPI island generating the message.

15. The system of claim 9 wherein the management agent receives the message from a processing unit.

16. The system of claim 9 wherein three filter bits are used to generate the broadcast list, the filter bits including: response_filter_sender, response_filter_ci, response_filter _pi.

17. A multiprocessing environment configured to filter broadcast recipients, comprising:
at least one computing chip;
a plurality of multiprocessing units connected to a plurality of coherent processing interfaces (CPI) on the computing chip via a QPI link;
a management agent associated with each CPI, the management agent configured to receive a message from one of the plurality of CPIs and determine which components in the multiprocessing environment already received the message, the management agent further configured to forward the message to only those components in the multiprocessing environment which did not already receive the message.

18. The multiprocessing environment of claim 17 further comprising a plurality of computing chips interconnected via a communications fabric.

19. The multiprocessing environment of claim 17 further comprising at least one I/O chip connected to at least one of the processing units via a QPI link, wherein the I/O chip is configured to generate and receive the message.

20. The system of claim 17 further comprising at least one QPI island in the multiprocessing environment, the QPI island including at least one processing unit.
